(19) United States
(12) Patent Application Publication
(10) Pub. No.: US 2012/0013063 A1
(43) Pub. Date: Jan. 19, 2012

(54) FOLDING MACHINE

(75) Inventors: Akimitsu Yamashita, Hiroshima-ken (JP); Isami Mitamura, Hiroshima-ken (JP); Mikio Motooka, Hiroshima-ken (JP)

(73) Assignee: Mitsubishi Heavy Industries, Ltd., Tokyo (JP)

(21) Appl. No.: 12/674,391

(22) PCT Filed: Aug. 20, 2008
(86) PCT No.: PCT/JP2008/064840

§ 371 Date: Feb. 19, 2010

(30) Foreign Application Priority Data
Aug. 23, 2007 (JP) 2007-217315

(51) Int. Cl. B41L 43/02

(52) U.S. Cl. 270/32

(57) ABSTRACT

Signatures of various paper types can be discharged and guided properly to impellers by providing a pair of discharging rollers 31 that can sandwich and discharge signatures S; an impeller 50 that is disposed under the pair of discharging rollers 31, is disposed with its rotation center offset toward one of the pair of discharging rollers 31, and can receive the signatures S discharged from the pair of discharging rollers 31 with a plurality of blades 56 provided at predetermined intervals in the circumferential direction; first guiding members 60a, 60b, 60c that configure a signature conveyance path K from the pair of discharging rollers 31 to the impellers 50, and are disposed on the center side of the impellers; second guiding members 61a, 61b, 61c that are disposed on the side opposite to the first guiding members 60a, 60b, 60c across the signature conveyance path K, and regulate deviation of the signatures S from the signature conveyance path K; and a guide-moving unit 68 that changes the path of the signature conveyance path K by moving the first guiding members 60a, 60b, 60c.

### TECHNICAL FIELD

The present invention relates to a folding machine that creates signatures by folding paper or the like.

### BACKGROUND ART

A conventional, known folding machine includes a pair of gripping rollers (discharging rollers) and a plurality of impellers arranged parallel with each other on an impeller shaft positioned obliquely under the pair of gripping rollers (see Patent Document 1). The folding machine includes a pair of signature guides supported by angle stays of sub frames through corresponding arms. One of the signature guides provided on the center side of the impellers sandwiches both sides of the entire width of the impellers, and the other one of the signature guides provided on the outer side of the impellers guides the conveyed signatures with their planes contacting on the signature guide.
[Patent Document 1] Japanese Examined Patent Publication No. H6-104535

### DISCLOSURE OF INVENTION

### Problem to be Solved by the Invention

Operation of the folding machine at higher speed is required to improve the processing capacity of the folding machine. Specifically, the pair of gripping rollers that discharges signatures is rotated at high speed, and correspondingly the impellers are rotated at high speed. This results in changing conditions of discharge of discharged signatures (e.g., flip-flop motion of the signatures) depending on the paper type of the signatures. At this time, because in a conventional folding machine, the two signature guides that are fixed to angle stays through arms cannot cope with the paper type of signatures, that is, the condition of discharge of the signatures, the signatures cannot be guided properly to the impellers from the pair of gripping rollers. As a result, scratch or smudge may appear on the signatures, and disturbance may occur during the paper discharge. Accordingly, when the impellers are operated at high speed, the signature guides need to be replaced appropriately with proper signature guides depending on the paper type of discharged signatures.

However, the replacement of the signature guides is done manually by an operator, which is troublesome. Additionally, because the folding machine needs to be stopped during the replacement for safety of the operator, for example, the stop of the folding machine lowers work efficiency.

An object of the present invention is to provide a folding machine that can guide discharged signatures properly to impellers even when the types of the signatures vary.

### Means for Solving Problem

According to an aspect of the present invention, a folding machine includes: a pair of discharging rollers that is configured to sandwich and discharge signatures; an impeller that is disposed under the pair of discharging rollers, is disposed with a rotation center thereof offset toward one of the pair of discharging rollers, and is configured to receive the signatures discharged from the pair of discharging rollers with a plurality of blades provided at predetermined intervals in a circumferential direction thereof; a first guiding member that forms a signature conveyance path from the pair of discharging rollers to the impeller, and is disposed on a center side of the impeller; a second guiding member that is disposed on a side opposite to the first guiding member across the signature conveyance path, and regulates deviation of the signatures from the signature conveyance path; and a guide-moving unit that changes the signature conveyance path by moving the first guiding member.

Advantageously, in the folding machine, the guide-moving unit changes the path by performing at least one of parallel movement and rotational movement of the first guiding member relative to the second guiding member.

Advantageously, in the folding machine, the guide-moving unit includes an actuator as a power source, and a power transmitting unit that transmits power of the actuator to the first guiding member, and the folding machine further includes a controlling unit that is configured to control the actuator.

### Effect of the Invention

Because the folding machine according to claim 1 includes the first guiding member that configures the signature conveyance path from the pair of discharging rollers to the impellers, and is disposed on the center side of the impeller; and the guide-moving unit that changes the signature conveyance path by moving the first guiding member, the guide-moving unit can move the first guiding member, and accordingly the signature conveyance path can be changed. Thereby, the discharged signatures can be properly guided to between the blades of the impellers by changing the signature conveyance path appropriately depending on the paper type of the signatures. Accordingly, the signatures can be accommodated between the blades of the impellers without scratch and smudge appearing on the signature, and without disturbance occurring during paper discharge.

In the folding machine according to claim 2, the guide-moving unit changes the path by performing at least one of parallel movement and rotational movement of the first guiding member relative to the second guiding member, the interval between the second guiding member and the first guiding member, the angle of the first guiding member relative to the second guiding member, and the like can be adjusted. Accordingly, the path of the signature conveyance path can be desirably changed, and the signature conveyance path can be suited for the discharged signature.

In the folding machine according to claim 3, the guide-moving unit includes the actuator as a power source, and the power transmitting unit that transmits power of the actuator to the first guiding member, and the folding machine further includes the controlling unit that can control the actuator, the first guiding member can be moved automatically. Thereby, the path can be changed while the folding machine is operated without an operator around the folding machine. Accordingly, no deterioration of the work efficiency of the folding machine due to replacement of the guiding members occurs.

### BRIEF DESCRIPTION OF DRAWINGS

FIG. 1 is a schematic of a web offset printing press to which a folding machine of the present embodiment is applied.

FIG. 2 is a schematic of the folding machine according to the present embodiment.

FIG. 3 is a cross-sectional view of main parts of the circumference of a guiding unit of the folding machine (a cross sectional view taken along the line A-A′ in FIG. 4).

FIG. 4 is a schematic plan view of the circumference of the guiding unit of the folding machine.

FIG. 5 is a schematic front view of the circumference of the guiding unit of the folding machine.

FIG. 6 is a front view of the circumference of an air cylinder.

### EXPLANATIONS OF LETTERS OR NUMERALS

9 folding machine
31 pair of folding rollers
50 impeller
52 guiding unit
56 blade
60a, 60b, 60c three first guiding members
61a, 61b, 61c three second guiding members
68 guide-moving mechanism
70 air cylinder
71 power transmitting mechanism
72 controlling device
S signature
W web
K signature conveyance path

### BEST MODE(S) FOR CARRYING OUT THE INVENTION

A web offset printing press to which a folding machine according to the present invention is applied is explained with reference to the attached drawings. The present invention is not limited by this embodiment.

### Embodiment

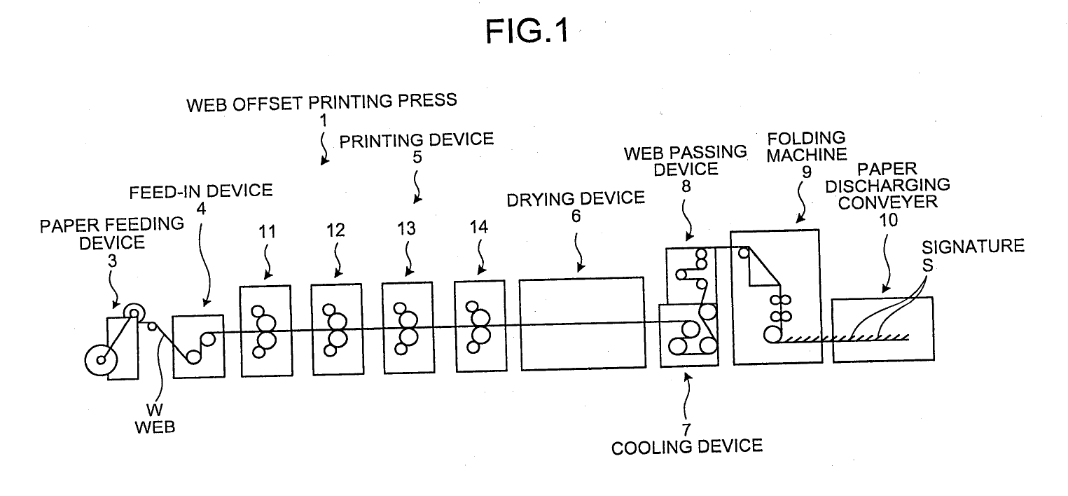

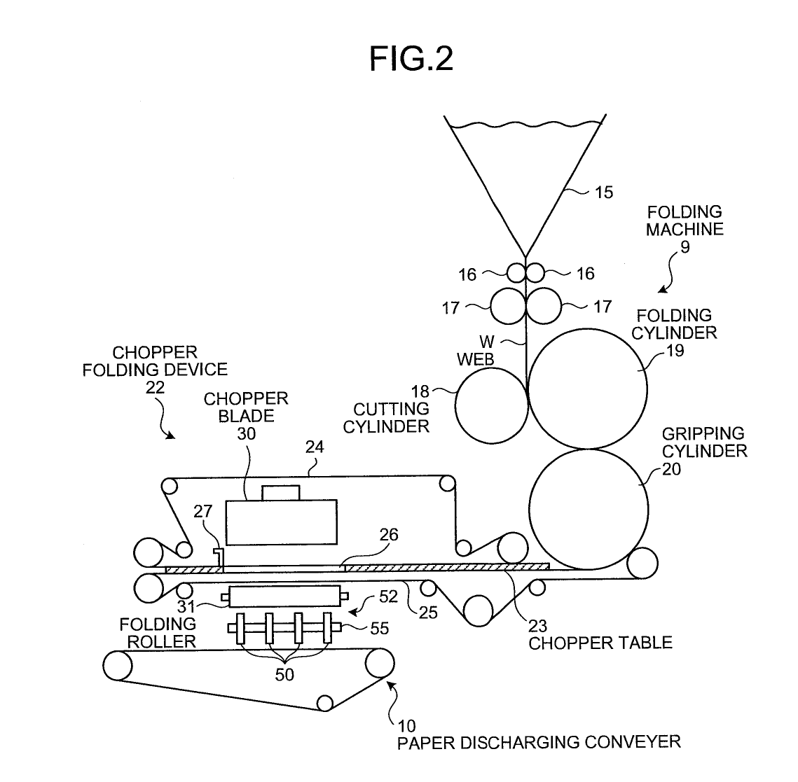

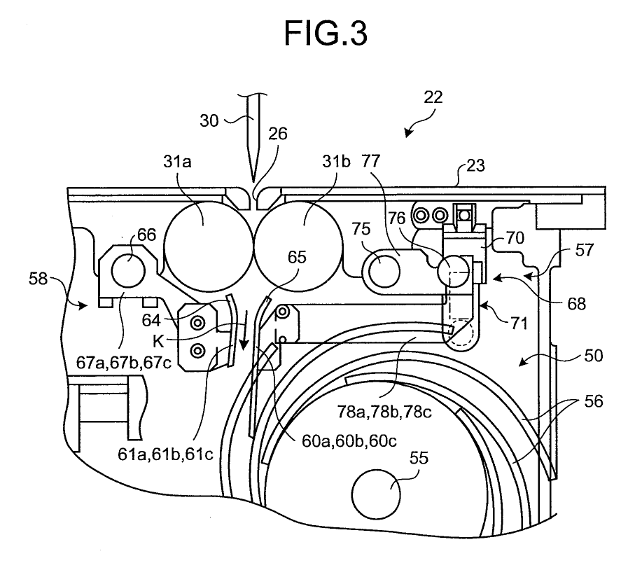

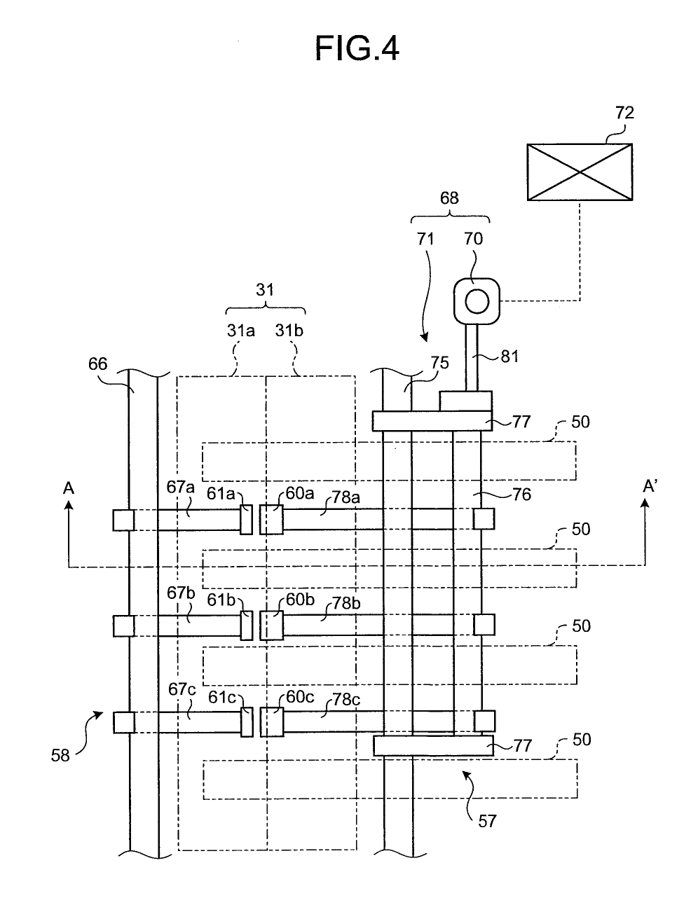

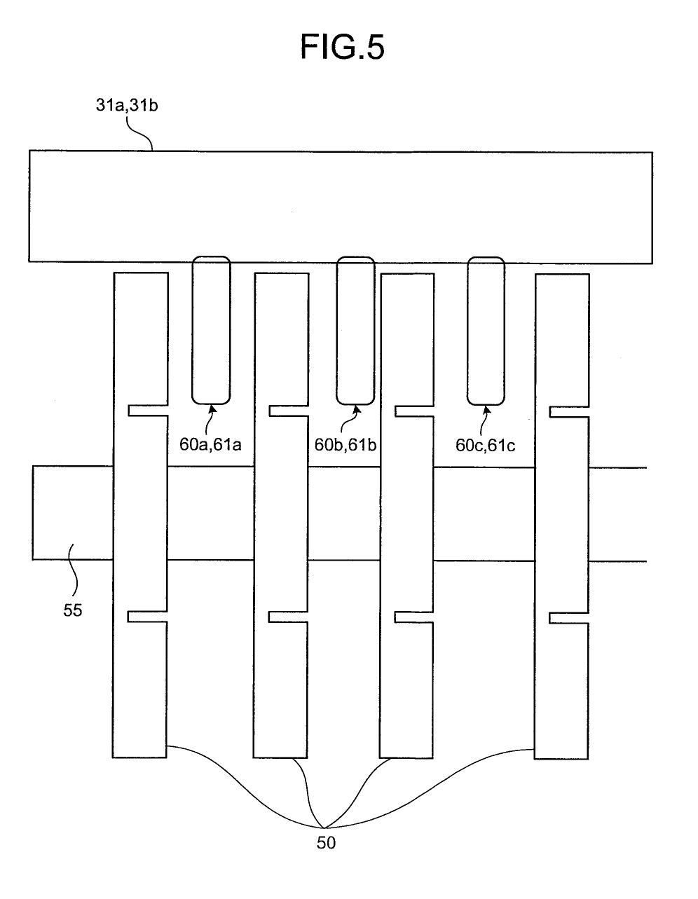

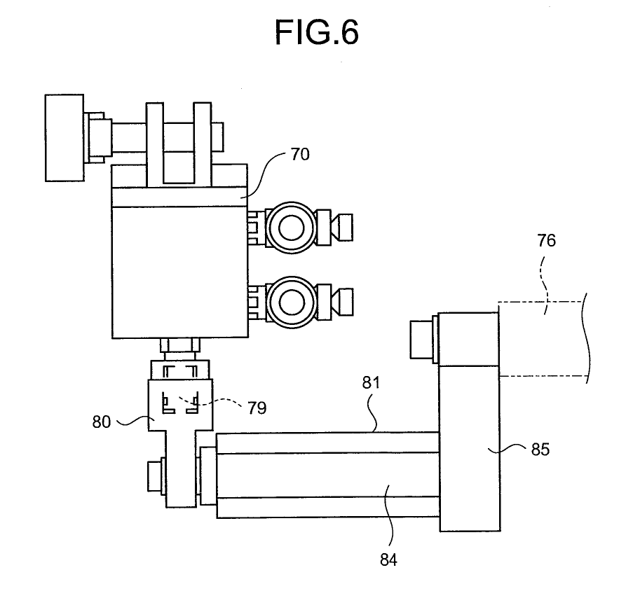

FIG. 1 is a schematic of a web offset printing press to which the folding machine of the present embodiment is applied. FIG. 2 is a schematic of the folding machine according to the present embodiment. FIG. 3 is a cross-sectional view of main parts of the circumference of a guiding unit of the folding machine (a cross sectional view taken along the line A-A′ in FIG. 4). FIG. 4 is a schematic plan view of the circumference of the guiding unit of the folding machine. FIG. 5 is a schematic front view of the circumference of the guiding unit of the folding machine. FIG. 6 is a front view of the circumference of an air cylinder.

As shown in FIG. 1, a web offset printing press 1 according to the present embodiment includes a paper feeding device 3, a feed-in device 4, a printing device 5, a drying device 6, a cooling device 7, a web passing device 8, a folding machine 9, and a paper discharging conveyer 10.

The paper feeding device 3 includes a reel stand on which two rewinding bodies (web rolls) are mounted, and can continuously supply webs W by connecting the web W traveling by being drawn from a rewinding body with the web W of the other rewinding body. The feed-in device 4 supplies the web W of the paper feeding device 3 toward the printing device 5. The printing device 5 includes printing units 11, 12, 13, 14 for four ink colors (cyan, magenta, yellow, and black) aligned in the web conveyance direction. The drying device 6 is for drying ink on the web W having been subjected to printing by the printing device 5. The cooling device 7 is for cooling the web W storing therein excessive heat after drying by the drying device 6 to a proper temperature. The web passing device 8 is for conveying the web W having been dried and cooled. The folding machine 9 is for cutting the web W after being folded longitudinally, and forming signatures S by folding the web into a predetermined size. The paper discharging conveyer 10 is for conveying the folded signatures S to the outside of the machine.

Accordingly, the paper feeding device 3 draws out the roll-like web W from the rewinding bodies; the feed-in device 4 supplies the web W to the printing device 5; the printing device 5 performs multicolor printing with the printing units 11, 12, 13, 14; the ink on the web W subjected to the printing is dried by the drying device 6; the web W is cooled by the cooling device 7; the web W is conveyed through the web passing device 8, and the folding machine 9 creates the signatures S; and the paper discharging conveyer 10 conveys the signatures S out.

The folding machine 9 according to the present embodiment is explained with reference to FIG. 2. The folding machine 9 includes a former (trigon) 15 that is provided at its top and folds the web W longitudinally, and includes a pair of lead-in rollers 16, and a pair of nipping rollers 17 provided under the former 15. A cutting cylinder 18, a folding cylinder 19, and a gripping cylinder 20 are disposed under the pair of nipping rollers 17 sequentially contacting with one another.

The cutting cylinder 18 includes a blade (not shown) provided at its circumference surface, and can cut the web W folded longitudinally into a predetermined length. The folding cylinder 19 includes a needle device (not shown) provided at its circumference surface. The needle device is activated interlocking with rotation of the folding cylinder 19. The needle device can hold a leading end of the cut web W in the conveyance direction by protruding a needle at a predetermined position outward, and on the other hand can release the holding of the leading end of the web W by housing the needle at a predetermined position. The folding cylinder 19 includes a knife (not shown) provided at its circumference surface, and can fold the cut web W horizontally at its central part in the conveyance direction by protruding the knife at a predetermined position outward. The gripping cylinder 20 includes a gripping device (not shown) provided at its circumference surface. The gripping device is activated interlocking with rotation of the gripping cylinder 20, and can grip and fold horizontally the central part of the web W protruded by the knife from the circumference surface of the folding cylinder 19 with this gripping mechanism.

Accordingly, after the web W is folded longitudinally by the former 15, the web W is guided and conveyed by the pair of lead-in rollers 16 and the pair of nipping rollers 17, and enters between the cutting cylinder 18 and the folding cylinder 19. Then, the needle device is activated, protrudes its needle outward at a predetermined position, and sticks the needles into the leading end of the web W and holds it. When the folding cylinder 19 continues its rotation in this state, the web W revolves around the folding cylinder 19. The web W is cut horizontally by a blade at a predetermined position. Then, the needle device is activated and houses its needle to release the holding of the leading end of the web W, and the knife protrudes outward from the circumference surface of the folding cylinder 19 to peel off the web W from the circumference surface of the folding cylinder 19. The web W protruding from the circumference surface of the folding cylinder 19 is then gripped by the gripping mechanism of the gripping cylinder 20 to form signatures S.

A chopper folding device 22 is provided adjacent to the gripping cylinder 20. As shown in FIGS. 2 and 3, the chopper folding device 22 includes a chopper table 23. The chopper table 23 is disposed horizontally. An upper conveying belt 24 is arranged above the chopper table 23, and a lower conveying belt 25 is arranged under the chopper table 23. The conveying belts 24, 25 include endless belts, a plurality of guiding rollers, and driving motors. The conveying belts 24, 25 can convey the signatures S released from the gripping cylinder 20 to a predetermined position on the chopper table 23.

The chopper table 23 includes a slit 26 formed at a predetermined position, and includes a stopper 27 provided adjacent to the slit 26. The chopper folding device 22 includes a chopper blade 30 that is provided above the slit 26, and contacts the central part of each signature S abutting on the stopper 27 to push it into the slit 26, and a pair of folding rollers 31 (discharging rollers) that are provided under the chopper table 23, and sandwich the signatures S having fallen from the slit 26 at a nip pressure, and bends them.

The chopper blade 30 is provided to be vertically movable, and can be moved vertically by a driving device (not shown). One of the pair of folding rollers 31, a folding roller 31b, is provided on the side of the impeller 50 relative to a signature conveyance path K explained below (the right side in FIGS. 3 and 4). The other one of the pair of folding rollers 31, a folding roller 31a, is provided on the side opposite to the folding roller 31b across the signature conveyance path K (the left side in FIGS. 3 and 4). The folding rollers 31a, 31b are provided to be rotatable (see FIG. 5).

The signatures S folded in quarto by the folding cylinder 19 and the gripping cylinder 20 are conveyed above the chopper table 23 by the upper and the lower conveying belts 24, 25, and stop at a position where the leading end abuts on the stopper 27. Then, the chopper blade 30 falls on the signatures S that stop at a reference position on the chopper table 23, the central part of each signature S is pushed into the slit 26 of the chopper table 23, and the pair of folding rollers 31 sandwich and bend the signatures S, letting the signatures S pass therethrough, thereby folding the signatures S.

As shown in FIGS. 3 to 5, four impellers 50 (only one of them is shown in FIG. 3) are provided under the pair of folding rollers 31. Although the detail is explained below, a guiding unit 52 that guides the signatures S along the signature conveyance path K is provided in the signature conveyance path K from the pair of folding rollers 31 to the four impellers 50.

The four impellers 50 are fixed parallel with each other on a single rotation shaft 55 (see FIG. 5), and when the rotation shaft 55 rotates, the four impellers 50 rotate integrally. The rotation shaft 55 is disposed offset toward the folding roller 31b of the pair of folding rollers 31 (the right side in FIG. 3), and is disposed parallel with the axial direction of the pair of folding rollers 31. The impellers 50 include a plurality of blades 56 in their circumferential direction.

When the four impellers 50 rotate in synchronization with the pair of folding rollers 31, the signatures S discharged from the pair of folding rollers 31 fall toward between the blades 56 of the impellers 50, and the four rotating impellers 50 receive and accommodate the discharged signatures S between the blades 56. Thereafter, the four rotating impellers 50 discharge the signatures S on the paper discharging conveyer 10 at the same timing. The paper discharging conveyer 10 can convey the arrayed signatures S to a next process by driving the conveying belt at a predetermined speed.

When the four impellers 50 are rotated at high speed to improve the processing capacity of the folding machine 9, the signatures S may not be guided properly from the pair of folding rollers 31 to the four impellers 50 depending on the paper type of the discharged signatures S, scratch or smudge may appear on the signatures S, and the signatures S may flip-flop, and may not be arrayed on the paper discharging conveyer 10. Accordingly, in the guiding unit 52 of the present embodiment, the signature conveyance path K is adopted suitably for the paper type of the discharged signatures S by changing its path, and the signatures S can be accommodated between the blades 56 of the four impellers 50 without making the signatures S fall down by guiding the signatures S properly from the pair of folding rollers 31 to the four impellers 50. The paper type means paper quality, paper thickness, or the like. The detail of the guiding unit 52 is explained with reference to FIGS. 3 to 6.

As shown in FIGS. 3 and 4, the guiding unit 52 includes a movable guiding unit 57 disposed on the center side of the impeller relative to the signature conveyance path K, and a fixed guiding unit 58 disposed on the side opposite to the movable guiding unit 57 across the signature conveyance path K.

The fixed guiding unit 58 includes a second fixed shaft 66 fixed to a device frame of the folding machine 9, three fixed guide arms 67a, 67b, 67c whose base ends are fixed to the second fixed shaft 66, and three second guiding members 61a, 61b, 61c fixed to the leading ends (the signature conveyance path side) of the three fixed guide arms 67a, 67b, 67c, respectively.

The three fixed guide arms 67a, 67b, 67c, and the three second guiding members 61a, 61b, 61c are disposed above the three gaps formed by the four impellers 50, respectively, and are provided parallel with the width direction of the signature conveyance path K orthogonal to the conveyance direction.

The second fixed shaft 66 is formed cylindrically, is provided on the side opposite to the folding roller 31b on the center side of the impeller (the right side in the figure) across the folding roller 31a of the outer side of the impeller (the left side in the figure), and is attached to the device frame of the folding machine 9 to be parallel with the axial direction of the pair of folding rollers 31.

Referring again to FIG. 3, the three second guiding members 61a, 61b, 61c are curved outward relative to the signature conveying path K, so that a signature introducing unit 64 that introduces the signatures S can introduce the signatures S smoothly into the signature conveyance path K.

The fixed guiding unit 58 is thereby fixed to the device frame of the folding machine 9, and the three second guiding members 61a, 61b, 61c regulate deviation of the signatures S from the signature conveyance path K.

On the other hand, the movable guiding unit 57 includes a guide-moving mechanism (a guide-moving unit) 68, and three first guiding members 60a, 60b, 60c that are moved by the guide-moving mechanism 68.

The guide-moving mechanism 68 includes an air cylinder 70 (an actuator) as a power source for moving the three first guiding members 60a, 60b, 60c, and a power transmitting mechanism 71 that transmits power of the air cylinder 70 to the three first guiding members 60a, 60b, 60c. Advancing/receding motion of the air cylinder 70 is controlled by a controlling device 72 (see FIG. 4) of the folding machine 9.

As shown in FIGS. 3 and 6, the air cylinder 70 is a reciprocating cylinder, and is attached to the device frame of the folding machine 9 at its base end with a cylinder rod 79 oriented downward.

As shown in FIG. 4, the power transmitting mechanism 71 includes a first fixed shaft 75 fixed to the device frame of the folding machine 9, a movable shaft 76 movable in the circumferential direction with the first fixed shaft 75 as the fulcrum, and a pair of shaft linking members 71 that links the first fixed shaft 75 and the movable shaft 76.

The first fixed shaft 75 is formed cylindrically, is provided on the side opposite to the folding roller 31a on the outer side of the impeller (the right side in the figure) across the folding roller 31b on the center side of the impeller, and is attached to the device frame of the folding machine 9 to be parallel with the axial direction of the pair of folding rollers 31. That is, the first fixed shaft 75 and the second fixed shaft 66 are disposed on both sides of the pair of folding rollers 31.

The movable shaft 76 is formed cylindrically, and is disposed on the side opposite to the folding roller 31b on the center side of the impeller across the first fixed shaft 75. The first fixed shaft 75, the second fixed shaft 66, and the movable shaft 76 are disposed parallel with each other, and disposed in the same horizontal plane.

The pair of shaft linking members 77 is fixed to both ends of the movable shaft 76 at its one end, and is rotatably attached to both ends of the first fixed shaft 75 at its other end. Thereby, the movable shaft 76 is movable in the circumferential direction of the first fixed shaft 75 with the first fixed shaft 75 as the fulcrum.

The power transmitting mechanism 71 includes three movable guide arms 78a, 78b, 78c that link the three first guiding members 60a, 60b, 60c to the movable shaft 76.

The movable guide arms 78a, 78b, 78c are formed into L-shape, and are fixed to the movable shaft 76 at their base ends. The three first guiding members 60a, 60b, 60c are attached to the leading ends of the movable guide arms 78a, 78b, 78c. Accordingly, when the movable shaft 76 moves, the three first guiding members 60a, 60b, 60c move integrally through the three movable guide arms 78a, 78b, 78c.

As shown in FIG. 6, the power transmitting mechanism 71 includes a rod jointing member 81 attached to the air cylinder 70, and a shaft joint member 80 that links the rod jointing member 81 and one end of the movable shaft 76.

The rod jointing member 81 is attached to the cylinder rod 79 of the air cylinder 70. The shaft joint member 80 is configured into L-shape with a rod linking unit 84 that links to the rod jointing member 81 and a shaft linking unit 85 that links to one end of the movable shaft 76. The rod linking unit 84 is attached to be orthogonal to the advancing/receding direction of the rod jointing member 81, and parallel with the axial direction of the movable shaft 76. The shaft linking unit 85 is linked integrally with the rod linking unit 84 on its bottom end side, and is linked with the movable shaft 76 on its upper end side. Thereby, advancing/receding motion of the air cylinder 70 can be transmitted to the movable shaft 76.

A series of action of changing the path by moving the three first guiding members 60a, 60b, 60c is explained. When the air cylinder 70 of the movable guiding unit 57 is activated by the controlling device 72 of the folding machine 9 to change the path of the signature conveyance path K, the air cylinder 70 moves forward the cylinder rod 79. When the cylinder rod 79 is moved forward, the movable shaft 76 turns downward with the first fixed shaft 75 as the fulcrum through the rod jointing member 81 and the shaft joint member 80. When the movable shaft 76 turns downward, the three movable guide arms 78a, 78b, 78c fixed to the movable shaft 76 turn with the first fixed shaft 75 as the fulcrum, and along therewith the three first guiding members 60a, 60b, 60c rotate with the first fixed shaft 75 as the fulcrum. That is, the three first guiding members 60a, 60b, 60c move while changing their inclination to the three second guiding members 61a, 61b, 61c. Specifically, the first guiding members 60a, 60b, 60c move toward the second guiding members 61a, 61b, 61c side so that the signature conveyance path K on the side of the impeller of the signature conveyance path K from the pair of folding rollers 31 to the four impellers 50 becomes narrower.

When the first guiding members 60a, 60b, 60c rotate and move, along with the rotation, the position of the guide surface on the side of the impeller of the first guiding members 60a, 60b, 60c that actively guide the signatures S move toward the second guiding members 61a, 61b, 61c side. Accordingly, the signatures S are guided to the four impellers 50 along the guide surface of the first guiding members 60a, 60b, 60c after its conveyance direction is changed, that is, after its path is changed.

On the other hand, when the signature conveyance path K the path of which is changed is to be returned to its original state, the movable shaft 76 is turned upward by making the air cylinder 70 recede, and the first guiding members 60a, 60b, 60c are returned to their original positions.

With this configuration, because the guide-moving mechanism 68 can move the three first guiding members 60a, 60b, 60c, the path of the signature conveyance path K can be changed. Accordingly, the signature conveyance path K can be switched appropriately depending on the type of the discharged signatures S, and the signatures S can be properly guided to between the blades 56 of the four impellers 50 even when the four impellers 50 are operated at high speed. Accordingly, the signatures S can be accommodated between the blades 56 of the four impellers 50 without scratch or smudge appearing on the signatures S, and without disturbance occurring during paper discharge.

By controlling the activation of the air cylinder 70 with the controlling device 72 of the folding machine 9, the three first guiding members 60a, 60b, 60c can be moved automatically. Accordingly, because the path can be changed while the folding machine 9 is operated without an operator around the folding machine 9, no deterioration of the work efficiency of the folding machine 9 due to replacement of the guiding member occurs.

Although in the present embodiment, the air cylinder 70 is used as an actuator, a solenoid may be used alternatively. A motor may be used as the actuator. In this case, the movable shaft 76 may be rotated and moved through a rack/pinion mechanism that converts rotation of the motor into linear motion, and the rotation angle of the movable shaft 76 may be made adjustable. Although in the present embodiment, the signature conveyance path K is changed by rotating and moving the first guiding member 60 relative to the second guiding member 61, the signature conveyance path K may be changed by moving the first guiding member 60 parallel with the second guiding member 61. That is, the three first guiding members 60a, 60b, 60c may be moved to narrow the width between themselves and the three second guiding members 61a, 61b, 61c while the inclination to the three second guiding members 61a, 61b, 61c is not changed but kept constant.

### INDUSTRIAL APPLICABILITY

The folding machine according to the present invention is useful for creating various types of signatures, and in particularly suited for rotating impellers at high speed.

1. A folding machine comprising:
a pair of discharging rollers that is configured to sandwich and discharge signatures;
an impeller that is disposed under the pair of discharging rollers, is disposed with a rotation center thereof offset toward one of the pair of discharging rollers, and is configured to receive the signatures discharged from the pair of discharging rollers with a plurality of blades provided at predetermined intervals in a circumferential direction thereof;
a first guiding member that forms a signature conveyance path from the pair of discharging rollers to the impeller, and is disposed on a center side of the impeller;
a second guiding member that is disposed on a side opposite to the first guiding member across the signature conveyance path, and regulates deviation of the signatures from the signature conveyance path; and
a guide-moving unit that changes the signature conveyance path by moving the first guiding member.

2. The folding machine according to claim 1, wherein the guide-moving unit changes the path by performing at least one of parallel movement and rotational movement of the first guiding member relative to the second guiding member.

3. The folding machine according to claim 1, wherein
the guide-moving unit includes an actuator as a power source, and a power transmitting unit that transmits power of the actuator to the first guiding member, and
the folding machine further includes a controlling unit that is configured to control the actuator.
